(19) United States
(12) Patent Application Publication
(10) Pub. No.: US 2008/0290216 A1
(43) Pub. Date: Nov. 27, 2008

(54) Method for Extinguishing Fire in Aircraft Compartment

(76) Inventors: Stephane Lessi, Newark, DE (US); Olivier Vandroux, Grenoble (FR)

Correspondence Address: AIR LIQUIDE;Intellectual Property, 2700 POST OAK BOULEVARD, SUITE 1800, HOUSTON, TX, 77056, US

(21) Appl. No.: 11/909,906

(22) PCT Filed: Mar. 23, 2006
(86) PCT No.: PCT/FR2006/050250

§ 371 Date: Jul. 21, 2008

(30) Foreign Application Priority Data
Mar. 31, 2005 (FR) 0550826

(51) Int. Cl. B64D 37/32

(52) U.S. Cl. 244/129.2

(57) ABSTRACT

The inventive method for extinguishing fire in an aircraft cargo compartment (3) consists in injecting a substantially pure nitrogen from high-pressure storage cylinders (12), in simultaneously actuating a device (5) for separating air and supplying nitrogen and in continuously introducing the nitrogen produced by said air separation device (5) into the compartment (3).

The present invention relates to systems for extinguishing fire on board aircraft.

Present-day systems use Halon 1301, the production and use of which have now been banned under the Montreal protocol. By way of a replacement, it has been proposed that a mist of water be generated in the compartment where fire has been detected. This solution, while admittedly effective, has the disadvantage of consuming vast quantities of water, adversely affecting the payload that can be carried, and entailing significant maintenance operations to top the water tanks back up each time they have been used.

It has also been proposed that use be made of the air separator technique to supply nitrogen (these generally being known by their English-language acronym OBIGGS) which are in any event used to inert the aviation fuel tanks. However, this solution has the disadvantage that the OBIGGS air-separation device has to be overspecified in order to be able quickly to supply large flow rates of nitrogen on the rare occasions that firefighting interventions are required, and thus also that the payload that can be carried is adversely affected.

It is an object of the present invention to propose a method for extinguishing fire in a compartment of an aircraft that allows swift and effective action with equipment that is low in cost and weight.

In order to do this, according to one feature of the invention, the method involves the steps of introducing a flow of substantially pure nitrogen from a nitrogen-storage device into the compartment of an aircraft in which a fire has broken out, of starting up an air-separation device that supplies the nitrogen, and of introducing nitrogen produced by the air-separation device into the compartment.

According to other features of the invention:
the method involves the step of continuing to introduce a small flow of nitrogen produced by the air-separation device into the compartment;
the nitrogen-storage device comprises at least one high-pressure cylinder;
the method involves the later step of refilling the cylinder with compressed nitrogen from the air-separation device.

It will be understood that the method according to the invention makes it possible, using the nitrogen-storage device, advantageously high-pressure cylinders, very quickly to establish within the compartment that is to be protected an oxygen concentration that is low enough to prevent the fire from spreading. The simultaneous starting-up of a small-sized and low-consumption air-separation device then allows this low oxygen concentration to be sustained for an unlimited length of time, thus setting aside any risk of the fire taking hold again later in the flight.

In addition, according to one aspect of the invention, by providing a small nitrogen compressor that can be connected to the output of the air-separation device, the pressurized nitrogen cylinders used and emptied during the initial phase of injecting nitrogen into the compartment can later, and in parallel time, be refilled with the nitrogen supplied by the air-separation device, thus greatly facilitating the maintenance of the system as a whole.

Other features and advantages of the invention will become apparent from the description which follows, of exemplary embodiments given by way of entirely nonlimiting illustration, with reference to the attached drawings in which:
the single FIGURE depicts a block diagram of a system for implementing a method according to the invention.

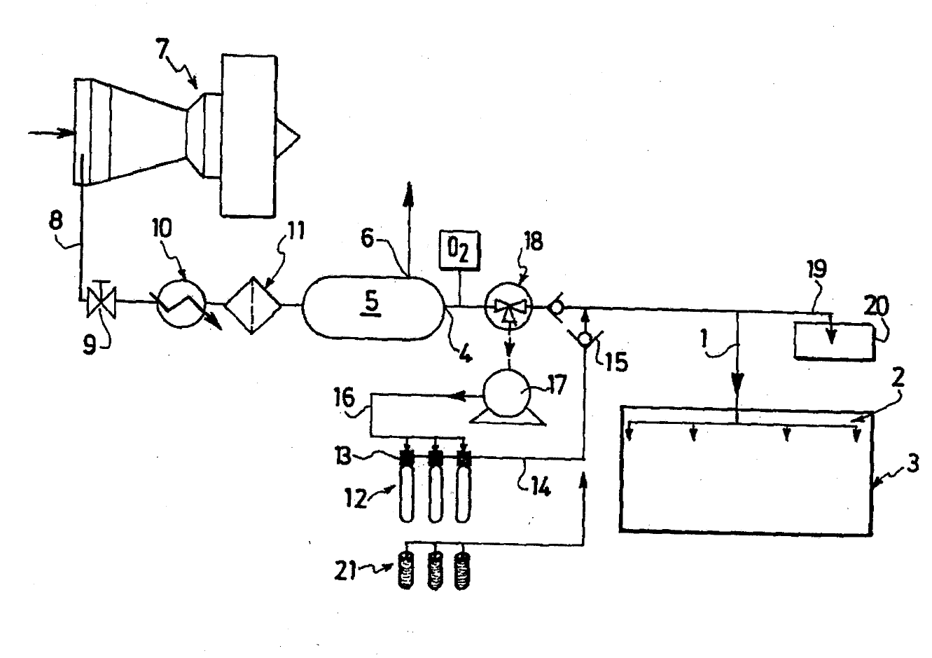

FIG. 1 shows a supply line 1 supplying a spray boom 2 for injecting gas at a low pressure, typically lower than 1.2 bar, into a hold 3, known as a “cargo compartment” of an aircraft (not depicted).

The line 1 is connected to the nitrogen production outlet 4 of an air-separation device 5, typically a polymer membrane permeator separating the nitrogen from the oxygen in the air, such as those marketed by the MEDAL Corp company of Wilmington, USA, the oxygen-enriched waste product being removed via an outlet orifice 6.

The separation device 5 is supplied with compressed air at a pressure of about 2 bar bled off a compression stage of a turbocompressor unit 7 of the aircraft, for example from a propulsion turbine engine or an auxiliary power unit APU.

The supply line 1 comprises, in series, a flow-regulating electrically-operated valve 9, a heat exchanger/cooler 10 and at least one filtration stage 11.

According to the invention, the fire-extinguishing system further comprises an array of pressurized nitrogen cylinders 12 capable of storing nitrogen under a pressure of between 150 and 300 bar and each provided with a pressure-reducing valve/regulator 13 so as to be able to supply nitrogen at a pressure not exceeding 2 bar to a line 14 connected to the line 1 via a nonreturn valve 15.

According to one advantageous aspect of the invention, a line 16 including a compressor 17 runs parallel to the line 14 between the cylinders 12 and a distributing valve 18 in the upstream part of the line 1. Advantageously, this line 1 is also connected to at least one line 19 for injecting fire-extinguishing nitrogen into at least one electrical equipment compartment 20 of the aircraft. Also as an alternative, an array of electrically controlled electro-chemical nitrogen generators 21, connected to the line 14, may be provided to supplement or take the place of the supplies of nitrogen from the cylinders 12.

It will be understood that, with the system which has just been described, if fire is detected in the hold 3 or in the compartment 20, the electrically operated valves of the distribution heads 13 of the cylinders 12 are immediately actuated to cause a substantial flow of pressure-reduced pure nitrogen to be injected into the compartment 3 by the spray boom 2. At the same time, the separation device 5 is started up to provide a lasting additional amount of nitrogen to the compartment 3, maintaining therein a low oxygen concentration that prevents fire from taking hold again.

With six 12- to 25-liter cylinders at a pressure of 200 bar and an air-separation device 5 comprising a single set of membranes it is possible in under four minutes to obtain in the compartment 3 an oxygen concentration of below 8% that can be maintained for several hours in spite of the compartment 3 exhibiting a leakage flow rate of about 40 Nm³/h (class C hold).

Although the invention has been described in conjunction with some particular embodiments, it is not restricted thereto but can be modified and varied in ways that will be evident to one skilled in the art within the context of the claims which follow.

1-7. (canceled)

8. A method of extinguishing fire in an aircraft compartment, involving the steps of:
a) introducing a flow of substantially pure nitrogen from a nitrogen-storage device into the compartment;
b) starting up an air-separation device that supplies the nitrogen; and
c) introducing nitrogen produced by the air-separation device into the compartment,
wherein the air fed into the air-separation device is compressed air at a pressure not exceeding 5 bar originating from a compression stage of a turbocompressor unit belonging to the aircraft.

9. The method of claim 8, involving the step of continuing to introduce a small flow of nitrogen produced by the air-separation device into the compartment.

10. The method of claim 8, wherein the air-separation device is a membrane permeator.

11. The method of claim 8, wherein the nitrogen-storage device comprises at least one high-pressure cylinder.

12. The method of claim 4, wherein it involves the later step of refilling the cylinder with nitrogen from the air-separation device.

13. The method of claim 12, wherein it involves the step of compressing the nitrogen from the air-separation device in order to fill the cylinder.

14. The method of claim 11, wherein the pressure of the nitrogen in the cylinder ranges between 150 and 300 bar.
